(19) United States
(12) Patent Application Publication
(10) Pub. No.: US 2012/0210663 A1
(43) Pub. Date: Aug. 23, 2012

(54) TRANSLUCENT DECKING PLANKS

(76) Inventor: ELAINE K. MAY, Lake Bluff, IL (US)

(21) Appl. No.: 13/398,299

(22) Filed: Feb. 16, 2012

Related U.S. Application Data
(60) Provisional application No. 61/444,625, filed on Feb. 18, 2011.

(51) Int. Cl. E04C 2/20; B32B 3/26

(52) U.S. Cl. 52/309.1; 428/151

(57) ABSTRACT

Decking comprises a translucent plank. The plank may be made from synthetic material. The plank may include a diffusion surface disposed to allow a portion of light incident on a top surface of the plank to transmit through a bottom surface of the plank.

### CROSS-REFERENCE TO RELATED APPLICATION

This application claims benefit under 35 U.S.C. §119(e) of U.S. Provisional Application having Ser. No. 61/444,625 filed Feb. 18, 2011, which is hereby incorporated by reference herein in its entirety.

### BACKGROUND OF THE INVENTION

The present invention generally relates to, construction materials, and more particularly to translucent decking planks.

Popularity of home improvement projects may create demand for outdoor products that have both a utilitarian and an aesthetic design. One area for outdoor home improvement projects is a patio deck. Patio decks offer a platform for congregating. Conventional patio decking may be wooden or synthetic material colored darkly to resemble wood. When situated on a second story or higher, patio decks can shade the area below. In some instances, the area under a patio deck may be overly darkened by the patio deck above thus requiring electric lighting for illumination.

As can be seen, there is a need for patio decking that may allow natural light to illuminate the area below the deck.

### SUMMARY OF THE INVENTION

In one aspect of the present invention, decking comprises a plank of synthetic material, the plank including a diffusion surface disposed to allow a portion of light incident on a top surface of the plank to transmit through a bottom surface of the plank.

In another aspect of the present invention, decking comprises a one-piece, molded plastic plank including through holes proximate ends of the plank; and an embossed grain texture disposed on the top surface of the plank.

In still yet another aspect of the present invention, a decking system comprises a plurality of one-piece, molded planks including through holes proximate ends of the plank, wherein the planks are made from a synthetic material adapted to diffuse light incident on a top surface of respective planks and configured to transmit the diffused light through the planks; and an embossed grain texture disposed on the top surface of the planks.

These and other features, aspects and advantages of the present invention will become better understood with reference to the following drawings, description and claims.

### BRIEF DESCRIPTION OF THE DRAWINGS

FIG. 1 is an oblique perspective view of a decking system according to an exemplary embodiment of the present invention in use;

FIG. 2 is a side perspective view of the decking system of FIG. 1 in use; and

FIG. 3 is a perspective top view of a plank of the decking system of FIG. 1 in accordance with another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide decking comprising a translucent plank. Aspects of the present invention provide a plank or board that allows light to be diffused and transmitted therethrough.

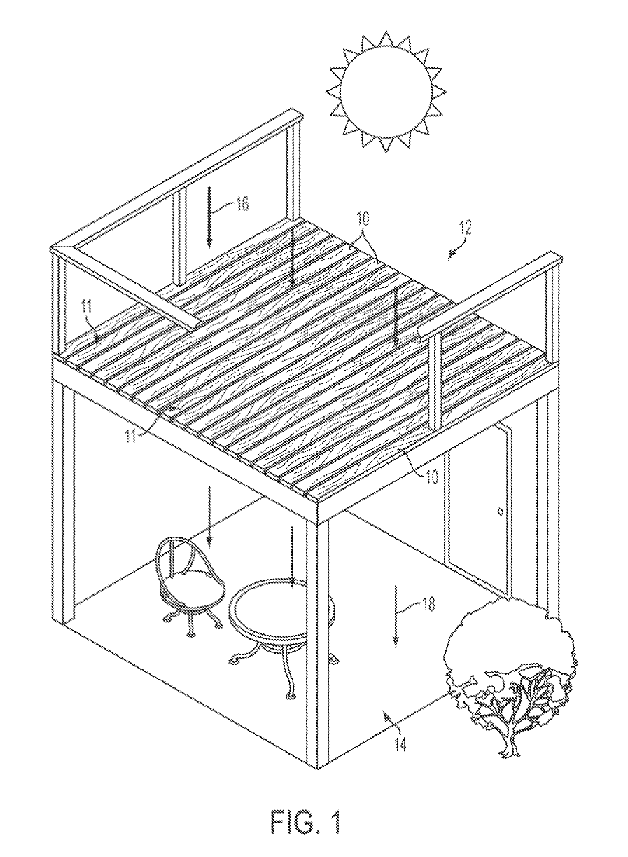

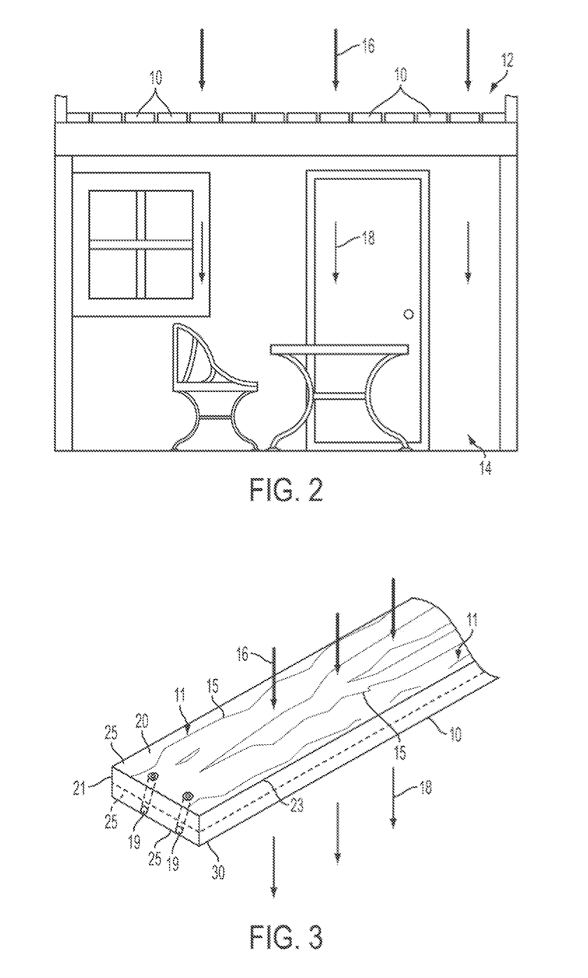

Referring to FIGS. 1-3, an exemplary embodiment a decking system 12 is shown. FIGS. 1-2 show the decking system 12 in an exemplary use. FIG. 3 shows an enlarged broken view of a plank 10 used in the decking system 12. A decking system 12 may include a plurality of planks 10. The planks 10 may be configured to be laid in juxtaposition to form a platform. The arrows 16 represent overhead natural light. The arrows 18 represent light transmitted through the decking system 12. In one aspect, the planks 10 may be configured to absorb overhead natural light 16 and diffuse the overhead natural light 16 so that a lower intensity diffuse light 18 is transmitted through the planks 10 to an area 14 below the decking system 12. The area 14 may be for example, an outdoor, ground floor patio. The arrows 16 are shown thicker than the arrows 18 to represent the lesser intensity of transmitted light 18 compared to the overhead natural light 16.

A plank 10 may be made from a translucent synthetic material. The synthetic material may be, for example, a hardened plastic, a resin, a ceramic, a laminate, or a composite. In an exemplary embodiment, the plank 10 may be a one-piece molded plank. The plank 10 may be extruded. The selection of the synthetic material for the plank 10 may be such that the plank 10 may be configured to resist rot, warping, chipping, slivers, and mildew. Additionally, in an exemplary embodiment, the plank 10 is capable of being cut by conventional tools including, for example, a circular saw and a miter saw.

The plank 10 may include a diffusion surface 25 disposed to allow a portion of light incident on a planar, top surface 20 of the plank 10 to transmit through a bottom surface 30 of the plank 10. The diffusion surface 25 may be disposed at the top surface 20, at the bottom surface 30, or intermediate the top surface 20 and bottom surface 30. In another exemplary embodiment, the diffusion surface 25 is disposed throughout the thickness of the plank 12 from the top surface 20 to the bottom surface 30.

In one aspect, the planks 10 may be configured to resemble wood. A plank 10 may include a textured surface 11 formed or machined on the top surface 20. The textured surface may be, for example, an embossed grain. In one aspect, the embossed grain 11 may provide decorative accents. For example, custom designs in the form of a square, diamond or circle comprised of the translucent decking material, combined with traditional wood or other current opaque synthetic decking materials, in specific areas only where light filtering below is required such as above a lower window, door, staircase, etc.; this would limit the amount of translucent decking material needed in order to achieve additional light reducing the need to do an entire upper deck of translucent material, thus, reducing costs. In another aspect, the embossed grain 11 may provide a diffusive element that refracts light incident on the top surface 20. The light 16 that transmits through the embossed grain 11 may be lessened in intensity as it is refracted by ridges 15 in embossed grain 11. In another aspect, the embossed grain 11 may provide traction for those traveling over the decking system 12 and may reduce a likelihood of slippage thereon. In another exemplary embodiment, the textured surface 11 may include a coarse, sanded texture.

Planks 10 may be pre-drilled to include through holes 19. The through holes 19 may be sized to fit conventional screws or other anchors, for example, wood screws and stainless steel finished screws. The through holes 19 may be positioned proximate ends 21. In one aspect, the through holes 19 may provide anchoring points so that the plurality of planks 10 may be positioned in uniformity to create the deck system 12 platform. In an exemplary embodiment, planks 10 may be about 5.5 inches wide, about 1.125 inches thick, and have varying lengths. In another exemplary embodiment, planks 10 may be manufactured in standardized construction or decking sizes including, 2 inch×4 inch×8 feet, 2 inch×4 inch×10 feet, 2 inch×4 inch×12 feet, and 2 inch×4 inch×16 feet. While the planks 10 are shown with straight edges 23, in another exemplary embodiment, the edges may be rounded. Rounded edges may blend better, as well as reduce potentially sharp edges. While the planks 10 are shown as single uncut lengths with through holes 19 proximate the ends, it will be understood that the through holes 19 may be positioned at various intervals along a plank 10. Thus, planks 10 may be cut at staggered lengths to provide an improved natural, free form look and feel.

It should be understood, of course, that the foregoing relates to exemplary embodiments of the invention and that modifications may be made without departing from the spirit and scope of the invention as set forth in the following claims.

What is claimed is:

1. Decking, comprising:
a plank of synthetic material, the plank including a diffusion surface disposed to allow a portion of light incident on a top surface of the plank to transmit through a bottom surface of the plank.

2. The decking of claim 1 comprising an embossed grain texture disposed on the top surface of the plank.

3. The decking of claim 1 comprising one or more through holes positioned proximate ends of the plank.

4. The decking of claim 1 wherein the plank is a one-piece molded plank.

5. The decking of claim 1 wherein the synthetic material is a hardened plastic.

6. The decking of claim 1 wherein the diffusion surface is positioned on the top surface of the plank.

7. The decking of claim 1 wherein the diffusion surface is positioned intermediate the top surface and the bottom surface.

8. Decking, comprising:
a one-piece, molded plastic plank including through holes proximate ends of the plank; and
an embossed grain texture disposed on the top surface of the plank.

9. A decking system, comprising:
a plurality of one-piece, molded planks including through holes proximate ends of the plank, wherein the planks are made from a synthetic adapted to diffuse light incident on a top surface of respective planks and configured to transmit the diffused light through the planks; and an embossed grain texture disposed on the top surface of the planks.
